(19) United States
(12) Patent Application Publication
(10) Pub. No.: US 2026/0253154 A1
(43) Pub. Date: Aug. 27, 2026

(54) INFORMATION PROCESSING METHOD, INFORMATION PROCESSING SYSTEM, AND NON-TRANSITORY COMPUTER-READABLE STORAGE MEDIUM

(71) Applicant: LegalOn Technologies, Inc., Tokyo (JP)

(72) Inventors: Akihiko MATSUBA, Tokyo (JP); Rihito ITO, Tokyo (JP); Aya OHATA, Tokyo (JP)

(73) Assignee: LegalOn Technologies, Inc., Tokyo (JP)

(21) Appl. No.: 19/651,381

(22) Filed: Apr. 17, 2026

Related U.S. Application Data
(63) Continuation of application No. PCT/JP2024/012994, filed on Mar. 29, 2024.

(30) Foreign Application Priority Data
Oct. 19, 2023 (JP) 2023-180140

(51) Int. Cl. G06Q 50/18; G06F 16/93

(52) U.S. Cl. CPC G06Q 50/18; G06F 16/93

(57) ABSTRACT

An information processing method executed by a processor includes: acquiring related information regarding a target document, based on a result of first analysis processing executed on the target document; generating review information regarding document information of the target document, based on second analysis processing regarding a risk included in the document information; and generating display information for displaying the related information and the review information on a screen on which the document information is displayed.

### CROSS-REFERENCE TO RELATED APPLICATIONS

This application is a continuation application filed under 35 U.S.C. § 111(a), claiming the benefit under 35 U.S.C. §§ 120 and 365(c) of International Application No. PCT/JP2024/012994, filed on March 29, 2024. The entire content of the above-identified application is incorporated herein by reference.

### BACKGROUND

### Technical Field

The present disclosure relates to an information processing method, an information processing system, and an information processing program.

### Related Art

Japanese Patent Application Laid-Open No. 2019-114264□describes a legal document review system including a UI output means that scores a character content in legal document data and displays and outputs whether or not a scoring result is advantageous to a user, together with a display content using at least one element of color, size, and shape.

### SUMMARY

An information processing method according to one aspect of the present disclosure is an information processing method executed by a processor, and the information processing method includes: acquiring related information regarding a target document, based on a result of first analysis processing executed on the target document; generating review information regarding document information of the target document, based on second analysis processing regarding a risk included in the document information; and generating display information for displaying the related information and the review information on a screen on which the document information is displayed.

### BRIEF DESCRIPTION OF DRAWINGS

FIG. 1 is a diagram illustrating a network configuration of a document review support system according to an embodiment of the present disclosure;

FIG. 2 is a diagram illustrating an example of functional blocks of an information processing device according to an embodiment of the present disclosure;

FIG. 3 is a diagram illustrating an example of functional blocks of a user terminal according to an embodiment of the present disclosure;

FIG. 4 is a flowchart illustrating a first example of document review support processing according to an embodiment of the present disclosure;

FIG. 5 is a diagram illustrating an example of a review support screen displayed on a user terminal according to an embodiment of the present disclosure; and

FIG. 6 is a diagram illustrating an example of a hardware configuration of a computer according to an embodiment of the present disclosure.

### DETAILED DESCRIPTION

Hereinafter, an embodiment will be described with reference to the accompanying drawings. The following embodiment is illustrative and is not intended to limit the present disclosure only to the embodiment. Furthermore, the present disclosure can be variously modified without departing from the gist thereof. Moreover, in each drawing, the same components may be denoted by the same reference numerals as much as possible, and redundant description will be omitted.

An object of some aspects of the present disclosure is to provide an information processing technology capable of supporting a user to easily review a target document.

According to the present embodiment, it is possible to support a user to easily review a target document.

In the present specification, a term “unit” does not simply mean a physical means but may include a case where a function of the “unit” is implemented by software. In addition, a function of one “unit” or device may be implemented by two or more physical means or devices, or functions of two or more “units” or devices may be implemented by one physical means or device.

### Document Review Support System

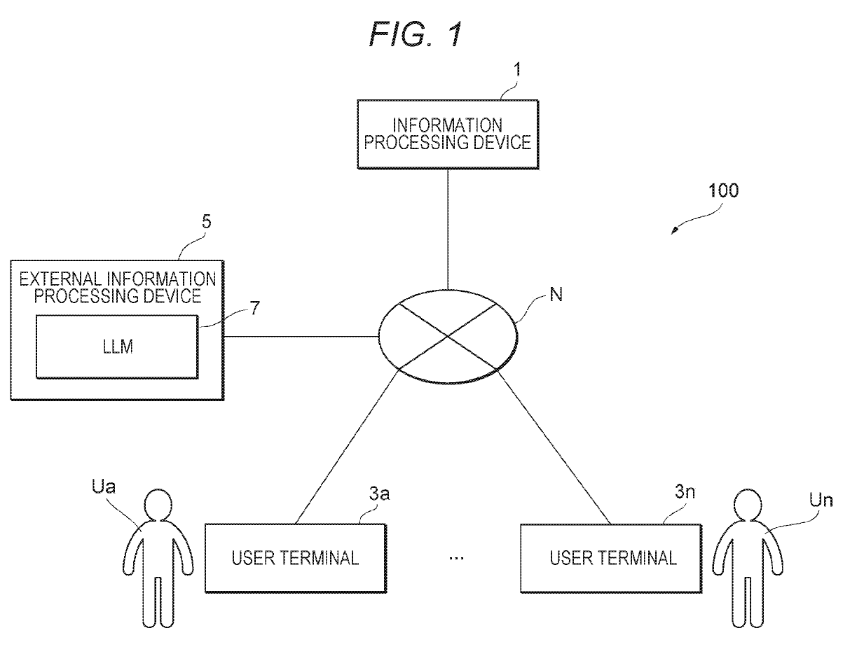

FIG. 1 is a diagram illustrating a network configuration of a document review support system 100 according to the present embodiment. The document review support system 100 of the present embodiment may function as, for example, a support system when a user browses and reviews a document. As illustrated in FIG. 1, the document review support system 100 may include, for example, an information processing device 1, an external information processing device 5, and at least one of user terminals 3a to 3n that can communicate with the information processing device 1 via a communication network N. The user terminals 3a to 3n may be operated by users Ua to Un, respectively, for example. Note that, in the following description, in a case where the n user terminals 3a to 3n are described without being distinguished, the user terminals 3a to 3n may be simply referred to as “user terminals 3” with a part of the reference numeral omitted. Furthermore, similarly, in a case where the users Ua to Un are described without being distinguished, the users Ua to Un may be simply referred to as “user U”.

In the present embodiment, a document may mean a document in any language, created according to a standard such as a certain rule, law, or custom, for example. Document information of a document of a review target (target document) may be information on the document. The document information may include, for example, information regarding body text or a content of the document. The document information can include, for example, various types of information such as image information and tabular information, in addition to text information.

The target document can include, as additional information, for example, meta-information (a version, a creation date, an update date, a creator, an updater, and the like), format information (a decoration such as an underline and a marker, a font, indent, and the like), change history information including information such as a change content, a change date, and a person who has made the change, comment information, chat information, and the like. The additional information may be created, updated, or edited by document creation software that has created and edited the document information, file browsing software, the document review support system 100, or the like. The comment information may include, for example, a comment attached inside the target document by document creation software such as Word, and data associated with the document in the document review support system 100. The chat information may include, for example, messages transmitted and received for a matter related to the target document. More specifically, the chat information may include, for example, message information transmitted and received via a predetermined online communication tool in the document review support system 100 according to the present embodiment, and information on an e-mail or a message of an external SNS captured by the document review support system 100. If the document has multiple different versions, the comment information may refer to data associated with a document of one version, for example, data related only to a document of a certain version, and the chat information may refer to data added to a matter regardless of the version of the document, for example, data related to the entire matter. As described above, in the present embodiment, by handling various types of additional information, appropriate information can be provided to a user.

Hereinafter, as an example, a case will be described in which a document handled by the document review support system 100 is a legal document (contract document) in Japanese. However, the document handled by the document review support system 100 may be a document other than the legal document. In addition to the contract document, the legal document may be, for example, a regulation in an organization or the like. In addition, the legal document handled by the document review support system 100 may be described in any language. For example, the legal document may be described in Japanese or English.

The document review support system 100 according to the present embodiment may perform, for example, processing regarding the following document review support functions.
(1) Executing first analysis processing on a target document, and acquiring related information regarding the target document on the basis of a result of the first analysis processing
(2) Generating review information regarding document information on the basis of second analysis processing (for example, document review processing) executed on the target document

Furthermore, the document review support system 100 according to the present embodiment can have a document creation support function, in addition to the above-described document review support functions. Here, for example, the document creation support function may include a function of editing (correcting, adding, deleting, and the like) a content of a support target document and a function of providing information for supporting editing. For example, the following processing can be included.

(3) Executing browsing or editing of the document

(4) Storing or providing the edited document to a user

(5) Editing additional information (for example, meta-information, comment information, chat information, format information, and the like) of the target document

(6) Creating a new document (including a copy, for example)

(7) Proofreading the target document

(8) Executing various types of processing using a translation display function

The editing function of (3) above may include editing body text of the document, and include, for example, editing the document by the user with reference to at least one of displayed review information or related information. The editing function of (3) above may include, for example, editing using a draft for correction proposal included in the review information. The editing function of (3) above may include, for example, at least one of creation, proposal, correction, or insertion of a correction draft in large language models (hereinafter, may be referred to as LLMs) or the like, based on or not based on the review information. The large language models may include, for example, bidirectional encoder representations from transformers (BERT), a generative pre-trained transformer (GPT), and the like, and may particularly include ChatGPT or GPT-4.

The editing function of (5) above for additional information of the target document may be, for example, a function of generating and editing a draft (for example, a draft of comment or chat information) regarding a reason of editing and a reason why a risk is present, by using an LLM 7 included in the external information processing device 5 (server) illustrated in FIG. 1, on the basis of at least one of the related information regarding the target document or a result of the document review processing regarding the document information. Specifically, for example, the comment can be generated by inputting, to the LLM 7, a prompt including a portion of body text of a document for which an indication is output in automatic processing review, a sentence of the automatic processing review result, and a command to generate an appropriate comment or the like using these. Such a draft may have a different content according to a purpose, for example. A function of creating an expression and a draft such as “comment for requester” for an internal requester or “comment for negotiation” for an external negotiation partner may be included. The draft can be changed, for example, by adjusting a prompt at the time of input to the LLM 7.

The translation function of (8) may include for example, displaying document information of a document and translation of the document in a parallel translation format, and displaying translation of review information and/or additional information in a parallel translation format, for example. In the translation function of (8) above, for example, an external service may be used for translation of at least one of the document, the review information, the related information, or the additional information. For example, information in Japanese to be translated can be transmitted to the external information processing device 5 of an external translation service, information translated into English can be received from a server of the translation service, and the translated information can be displayed to the user. Note that the parallel translation may preferably be displayed in certain units, for example, in units of sections and paragraphs of a contract document, such that an original sentence and a translated sentence that correspond to each other are arranged side by side. This may allow the user to easily review the document. Note that, it is also possible to include a function of outputting the translated sentence or the parallel translation in a predetermined file format and allowing the user to download the translated sentence or the parallel translation.

### Information Processing Device

The information processing device 1 of the present embodiment may be a device that is communicably connected to the user terminal 3 as a client device and performs various types of processing in response to a request from the user terminal 3. The information processing device 1 may be, for example, one or a plurality of server devices managed by a business operator that provides a document review support service. For example, the information processing device 1 may provide a document review support service including document creation support to the user terminal 3, in response to a sentence instruction received from the user terminal 3 via the communication network N.

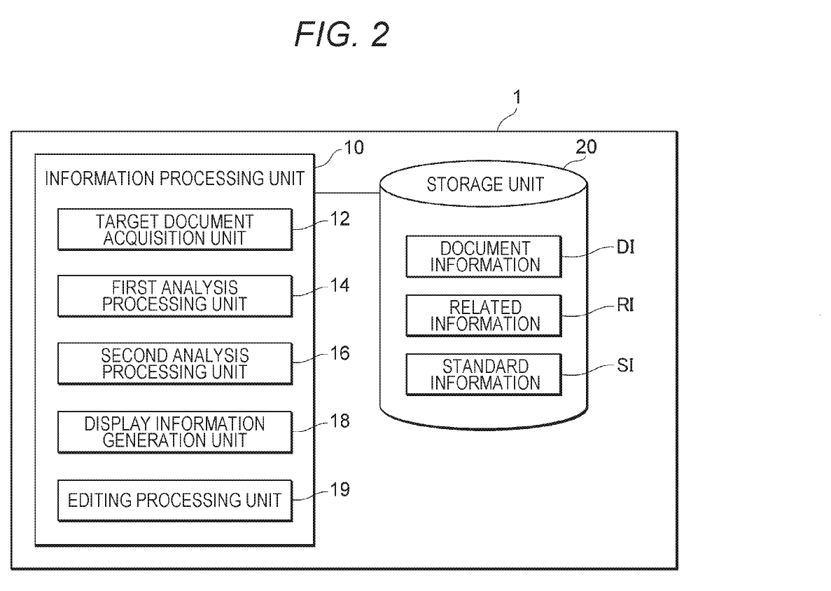

FIG. 2 is a diagram illustrating an example of functional blocks of the information processing device according to the present embodiment. As illustrated in FIG. 2, the information processing device 1 may include, for example, an information processing unit 10 and a storage unit 20 that stores information for the information processing unit 10 to execute various types of processing and information obtained as a result of the execution.

The information processing unit 10 of the present embodiment may include, for example, a target document acquisition unit 12, a first analysis processing unit 14, a second analysis processing unit 16, a display information generation unit 18, and an editing processing unit 19. Note that each of the above-described units of the information processing unit 10 can be implemented, for example, by using a storage area such as a memory or a hard disk or by executing a program stored in the storage area with one or a plurality of processors.

The target document acquisition unit 12 according to the present embodiment may acquire a document as a review target document. For example, the target document acquisition unit 12 may receive and acquire document data stored in a storage unit of another device (for example, the user terminal 3 illustrated in FIG. 1, an online storage service, or the like) via the communication network N. In addition, the target document acquisition unit 12 may receive and acquire a document file attached to an e-mail, or may receive and acquire a document file transmitted from a chat service or an SNS outside the system. Furthermore, the target document acquisition unit 12 may acquire a document (for example, document information DI) newly created in the information processing device or system and stored in the storage unit 20. Furthermore, the review target document may be, for example, a document created and edited on the system on the basis of a document template registered in advance in the information processing device.

The review target document may be created or transmitted to the system by a terminal or a user different from a terminal or a user that makes a review support request. For example, a document file transmitted by a requester who belongs to a department other than a legal department and requests the legal department to examine a contract document created by the other party may be received and acquired as the review target document. Examples of a file format of the review target document may include a DOCX format and a PDF format. In addition, the file format is not limited to a form of a file including sentences in body text, and may be text data or the like stored in a database.

The document review support system 100 can manage review of the target document as a matter. For example, the document review support system 100 can have: a task management function of each user, for example, a function of managing an answer deadline of a matter and issuing a notification regarding a matter whose deadline is close; an assignment function of assigning a user as a person in charge of a matter; and a management function of managing the number and progress of matters handled or processed by all users or each user.

The first analysis processing unit 14 of the present embodiment may acquire related information regarding the target document. The first analysis processing unit 14 may execute, for example, first analysis processing and acquires related information on the basis of a result of the obtained information. The first analysis processing unit 14 may extract, for example, information that is included in the target document and is necessary for analysis. Various techniques can be adopted as a method for extracting information from the target document. For example, the method may include performing keyword search of a document and extracting characters and numerals and the like included in the vicinity of the keyword, and extracting information by at least one analysis of morphological analysis, syntax analysis, semantic analysis, or context analysis. In addition, examples of the method may include natural language processing using machine learning, in particular, inputting data related to the review target document and a command (prompt) capable of extracting information from the review target document into a large language model, and obtaining a necessary output, and the like.

In addition, the document data may be processed prior to these types of processing. For example, information necessary for analysis of text data or the like related to body text of the document or for facilitating the analysis may be extracted from the received document. It is also possible to perform processing of extracting text data related to the body text of the document from image data such as PDF and TIFF by processing such as OCR. Furthermore, the target document may be divided on the basis of appropriate units, for example, units such as sections, paragraphs, items, or the like of a legal document. These types of processing may be performed by the first analysis processing unit 14, may be performed by another processing unit of the system, or may be performed by an information processing device outside the system. Further, the processing may be performed at the time of the first analysis processing, or may be performed in advance, for example, after a file is stored in the storage unit and before a start of the first analysis processing.

The first analysis processing unit 14 of the present embodiment may use, for example, information extracted by the method described above to acquire a determination result of a contract type, which is an example of the related information, from the body text of a target contract document that is the target document. Thereafter, the first analysis processing unit 14 may acquire, for example, information regarding another contract document of a type same as or similar to the target contract document from related information database RI stored in the storage unit 20.

In the present specification, the related information may be information regarding the target document, and in particular, may be information that is considered to be useful in reviewing the document. For example, the related information may be information that can be a guideline for propriety of description of the document or consideration of correction. Specifically, examples of the related information may include a document, or information related thereto, having a sentence similar to that of the target document, and a document having any common point or similar point, such as a case where a related party, an issue, or a target case is the same. In a case where the target document is a contract document, examples of the related document may include a similar contract document, a related contract document including a master contract document, an individual contract document and a memorandum based on the master contract document, a template of the same contract type as the target document, and the like. In addition, in a case where the target document is a legal document, examples of the related document may include a law (for example, the Subcontract Act and the like in a case where the target document is a contract document related to a subcontract), a guideline issued by a government office, and a case such as legal precedent, that are related to the document. Furthermore, for example, disclosed information may be included such as a website including a content related to the target document, data of a book in an electronic book service, and the like. In addition, the related information may also include a past case of a user or an organization to which the user belongs, chat information such as conversation accumulated in the system, comment information attached inside the document, a message such as an e-mail or SNS transmitted to and received from a requester or the other party of contract negotiation, and data such as a file held inside and outside the system by the user.

Note that the related information may be a part or an outline of the information described above. For example, the related information may include one or a plurality of provisions in the contract document, a snippet of an electronic book or a website, a summary of the contract document, a title or a link indicating the type of information described above, and the like. The related information of the present embodiment may include a contract type of the target document, a name of the contract document stored in the related information database RI so as to be displayed in a case of the contract type, a link that allows acquisition of data of the contract document, body text of the contract document, information obtained by processing these, and the like. In addition, the first analysis processing may be performed by a computer or the like outside the system, and the first analysis processing unit in the present system may only acquire the related information regarding the target document.

For example, when the contract document is divided in units of provisions, the first analysis processing unit 14 may give, as attribute information, to each of the divided provisions, result information (for example, a provision ID indicating a content meant by the provision and a type of the provision, and the like) analyzed in the first analysis processing, in addition to the related information. According to this configuration, when the user selects a provision of the contract document as a review target, the first analysis processing unit 14 may refer to the attribute information given to the selected provision, and can search the storage unit for a provision having a high degree of relevance, specifically, having the same provision ID, and present the provision to the user.

The second analysis processing unit 16 of the present embodiment may generate review information regarding document information. For example, the second analysis processing unit 16 may use document information of the target document acquired by the target document acquisition unit 12 to execute the second analysis processing regarding a risk included in the document information of the target document, and acquires the review information.

Various techniques can be adopted for the second analysis processing (hereinafter, may be referred to as document review processing). In the document review processing, for example, the review information may be generated on a rule basis using the extracted information. Furthermore, in the document review processing, it is also possible to use a learned model such as a large language model (LLM) that receives the extracted information as an input and outputs corresponding document review information. Furthermore, it is also possible to adopt a combination of a rule-based method and a learned model.

The review information generated by the document review processing executed by the second analysis processing unit 16 of the present embodiment may be generated on the basis of information obtained by analyzing the target document, for example, on the basis of a standard applied to the document (for example, standard information SI stored in the storage unit 20, including rules, laws, customs, and the like). For example, the following may be included as the review information of a contract document: (1) indication on whether articles contained in the document (contract document in the present embodiment) are advantageous or disadvantageous to a user or an organization to which the user belongs (party); (2) reference information such as guidelines for correction and deletion of the articles contained in the contract document, and drafts for correction; (3) indication that an item that should be normally contained in the contract document is missing, and proposal of a draft and an item that should be added; and (4) information on importance and a recommendation level of each review result item.

In a case where the target document is a contract document, the review information exemplified in (1) to (4) above and the like may be referred to as contract review information. By using the above information, a user can easily grasp a legal risk included in the contract document and perform contract review including correction proposal. Furthermore, the review information may include format information indicating, for example, whether a format of a sentence in the target document meets a standard, and information on whether a prescribed term is used, for example.

The information on the standard applied to these documents may be set by a vendor of the system, or may be set by a user or an organization to which the user belongs. For example, a user can register a standard indicating an examination standard of a contract document of the user's own company and a draft or an indicated matter related to the standard in the system, and use the standard and the draft or the indicated matter for the document review processing.

In a case where the target document has been completed, the document review processing may include an analysis (hereinafter, also referred to as “risk check processing”) of a risk included in the target document that has been completed. For example, examples of the completed target document may include a contract document for which an agreement with the other party, seal, and conclusion have been made, or an internal rule or the like that has been approved in a predetermined company procedure or that has been enforced. As an example, the risk check processing may involve determining a risk (residual risk) for one of the contracting parties within a contract document. This document may be referred to as a “risk management target document” and represents a contract agreed upon among multiple parties, such as Company A and Company B. The processing may utilize this target document in conjunction with data from a “reference document.” This reference document may serve as a standard for the contract of a specific party, such as Company A. Ultimately, the results of this determination may be presented to a user. Note that risk information data including the result of the risk check is an example of the review information.

A target risk to be checked by the risk check processing may include at least one of, for example, (1) a risk assumed from an article, an expression, and wording that are included in the reference document but are not included in the risk management target document, (2) a risk assumed from an article, an expression, and wording that are not included in the reference document but are included in the risk management target document, (3) a risk assumed from an article, an expression, and wording that are included in both the reference document and the risk management target document, or (4) a risk assumed due to presence of an article, an expression, and wording that are not included in the reference document or the risk management target document. Note that the document review processing using the reference document, which is similar to the risk check processing described above, may be performed on a contract document or the like before completion (that is, under examination).

Additional information (for example, the meta-information described above) of the target document may be used in the document review processing. For example, information on a position (for example, a client side or a contractor side in a service agreement) of the user (party) may be used as the additional information, to generate more appropriate document review information. Furthermore, in the document review processing, a result of the first analysis processing or the related information may be acquired, and the target document may be reviewed on the basis of these pieces of information. That is, the information obtained in the first analysis processing may be used for the second analysis processing. Furthermore, the second analysis processing unit 16 can also generate the document review information by referring to a content of another document (another version of the support target document, another contract document relevant to the target document, and the like). Note that, in the present specification, the meta-information may include information given to a document file itself of a creator or the like of the document and information given by a user or the like by being input separately from the file.

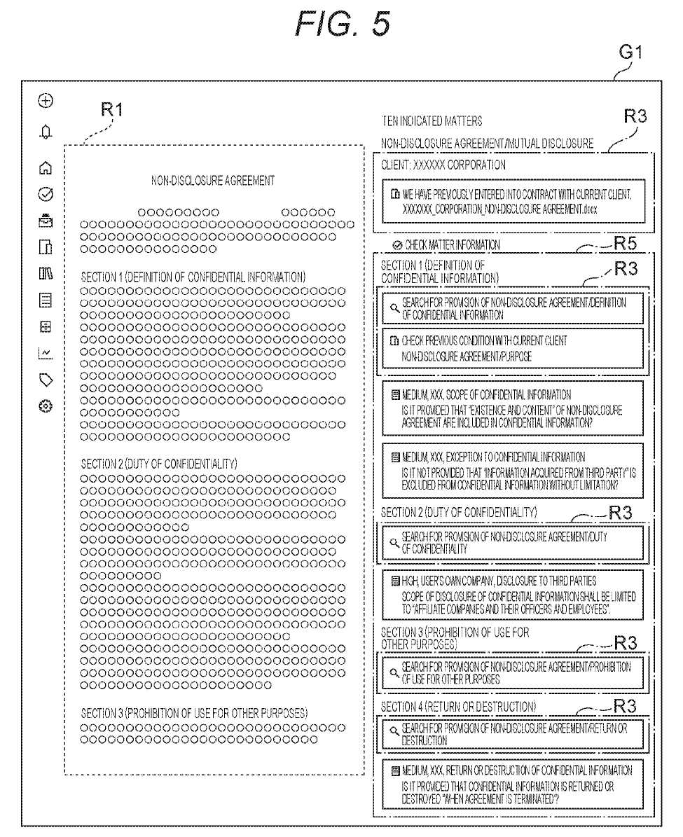

The display information generation unit 18 of the present embodiment may generate display information for displaying the related information and the review information on a review support screen (for example, FIG. 5 to be described later) on which the document information is displayed. Upon generating the display information, the display information generation unit 18 may transmit the generated display information to the user terminal 3. Upon receiving the display information, the user terminal 3 can display the review support screen on a display as, for example, an input/output interface 44 to be described later on the basis of the display information. Note that layout information regarding a layout of the review support screen may be information included in the display information or may be information different from the display information. Furthermore, the layout information may be generated in the information processing device 1 or may be generated in the user terminal 3.

The editing processing unit 19 of the present embodiment may have the document creation support function described above. The document creation support function described above may include, for example, a function of editing (correcting, adding, deleting, and the like) a content of a support target document and a function of providing information for supporting editing.

### User Terminal

The user terminal 3 of the present embodiment may transmit and receive information regarding document display and document editing to and from the information processing device 1 in the document review support service. The user terminal 3 may constitute a part of the document review support system. The user terminal 3 may be implemented by, for example, a desktop computer, a laptop computer, a smartphone, or the like.

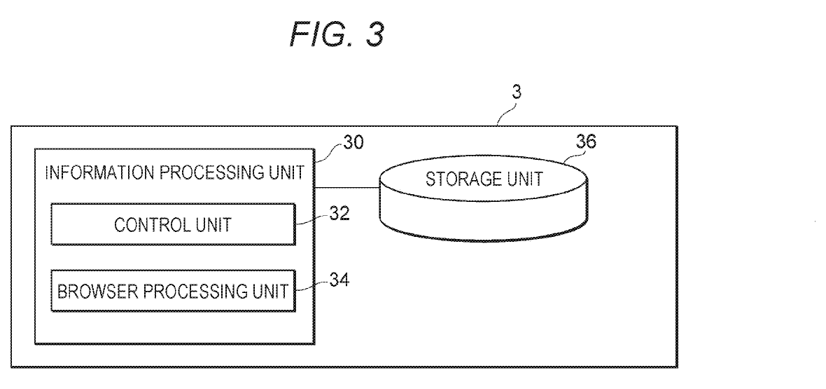

FIG. 3 is a diagram illustrating an example of functional blocks of the user terminal according to the present embodiment. As illustrated in FIG. 3, the user terminal 3 may include, for example, an information processing unit 30 and a storage unit 36 that stores information for the information processing unit 30 to execute various types of processing and information obtained as a result of the execution.

The information processing unit 30 of the present embodiment functionally may include, for example, a control unit 32 and a browser processing unit 34. Each of the above-described units of the information processing unit 30 can be implemented by using, for example, a storage area such as a memory or a hard disk, or by executing a program stored in the storage area with one or a plurality of processors.

The control unit 32 of the present embodiment may start an application capable of performing processing and display according to the present embodiment, such as the browser processing unit 34, in response to an instruction from the user.

The browser processing unit 34 of the present embodiment may be, for example, a general web browser, and execute processing according to hyper text markup language (HTML) data, a script, or the like. For example, when being activated, the browser processing unit 34 may transmit an initial access URL to the information processing device 1 illustrated in FIGS. 1 and 2 to access.

For example, the browser processing unit 34 may display data including text data, image data, and the like received from the information processing device 1, on a display of the user terminal 3 in a predetermined form. For example, the browser processing unit 34 may display the data on the display of the user terminal 3 in a predetermined form, on the basis of display information (for example, document information, related information, review information, additional information, and layout information thereof) received from the information processing device 1. In the document editing processing, the browser processing unit 34 may display the data on the display of the user terminal 3 in a predetermined form, on the basis of the display information received from the information processing device 1, for example.

The storage unit 36 of the present embodiment may store, for example, a target document before review or before editing processing. The storage unit 36 may store a target document after the review or after the editing processing acquired by the browser processing unit 34. The storage unit 36 may at least temporarily store the display information received from the information processing device 1.

### First Example

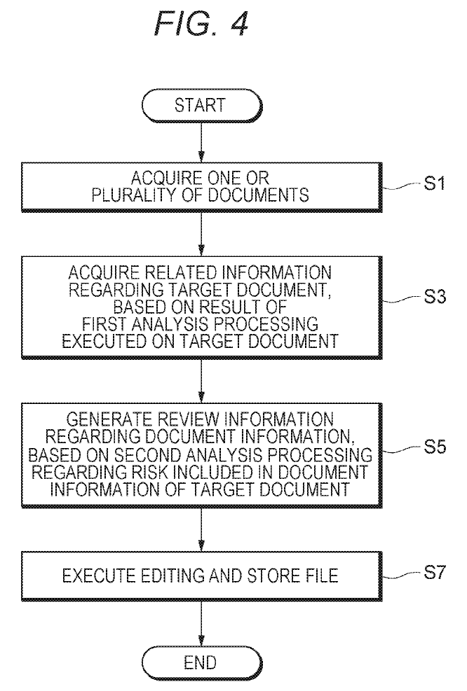

With reference to FIGS. 4 and 5, a first example of the document review support processing according to the present embodiment will be described. FIG. 4 is a flowchart illustrating the first example of the document review support processing. As a premise, in the user terminal 3 illustrated in FIG. 1, for example, the browser processing unit 34 illustrated in FIG. 3 may be activated in response to an instruction from the user. The browser processing unit 34 may transmit, for example, login information such as a registration ID to the information processing device 1.

For example, the information processing device 1 may execute authentication processing in response to the login information from the user terminal 3. For example, the information processing device 1 may generate home screen information for displaying a home screen on the user terminal 3 and transmit the home screen information to the user terminal 3. Note that the home screen may be, for example, a screen including a list of matters that the user is in charge of, or a dashboard screen on which a deadline or the like regarding a matter can be confirmed.

As illustrated in FIG. 4, the information processing device 1 according to the present embodiment may acquire one or a plurality of documents as target document candidates (step S1). For example, the information processing device 1 may acquire the target document from another device such as the user terminal 3 via the communication network N. In this case, for example, upon receiving the home screen information from the information processing device 1, the user terminal 3 may display the home screen on the display on the basis of the home screen information. Upon receiving an upload operation for the one or a plurality of documents by the user on the home screen, the user terminal 3 may upload the document to the information processing device 1. Furthermore, the document may be uploaded from the user terminal 3 via, for example, an e-mail, a chat tool such as Slack or Teams, an SNS, a transmission form on a website provided by a system, or the like. The one or a plurality of documents may be displayed on the user terminal 3 so as to be selectable as the target document, at the time of being uploaded or immediately after being uploaded.

For example, the information processing device 1 according to the present embodiment may acquire related information regarding the target document on the basis of a result of the first analysis processing executed on the target document (step S3). For example, when the one or a plurality of documents are uploaded from the user terminal 3, the information processing device 1 may execute the first analysis processing on the document. According to this configuration, at the time when the one or a plurality of documents that can be selected as a target document of a review target are uploaded, the first analysis processing may be executed for each document in advance, and a result of the first analysis processing may be stored in the storage unit 20 illustrated in FIG. 2. Therefore, by acquiring the result of the first analysis processing for each document in advance, subsequent acquisition processing of related information can be smoothly executed. In the first analysis processing, as described above, for example, text information regarding body text of the document may be extracted from the document using OCR or the like.

In step S3, on the basis of the selected target document and the result of the first analysis processing, the information processing device 1 may acquire the related information RI associated with the selected target document, from the storage unit 20 illustrated in FIG. 2, for example.

The information processing device 1 according to the present embodiment may generate review information regarding document information, on the basis of the second analysis processing regarding a risk included in the document information of the target document (step S5). For example, when one or a plurality of documents are uploaded from the user terminal 3, the information processing device 1 may execute the second analysis processing on the document. According to this configuration, at the time when the one or a plurality of documents that can be selected as a target document of a review target are uploaded, the second analysis processing may be executed for each document in advance, and a result of the second analysis processing may be stored in the storage unit 20 illustrated in FIG. 2. Therefore, it is possible to generate the result (review information) of the second analysis processing for each document in advance before a request of the user. As a result, information can be promptly provided to the user.

The information processing device 1 may transmit, to the user terminal 3, the display information for displaying the document information DI, the related information RI, and the generated review information on the review support screen of the user terminal 3. Upon receiving the display information for displaying the document information DI, the related information RI, and the review information on the review support screen of the user terminal 3, the user terminal 3 may display the document information DI, the related information RI, and the review information on a review support screen G1 as illustrated in FIG. 5.

FIG. 5 is a diagram illustrating an example of the review support screen displayed on the user terminal according to the present embodiment. As illustrated in FIG. 5, on the review support screen G1, at least the document information DI

may be displayed in a document information display area R1, the related information RI may be displayed in a related information display area R3, and the review information may be displayed in a review information display area R5. Any display form may be adopted for the document information DI, the related information RI, and the review information. For example, it sufficies that the document information DI, the related information RI, and the review information may be displayed on the review support screen G1 so as to be visually recognizable by the user, and a display size and a display position of the document information display area R1, the related information display area R3, and the review information display area R5 can be appropriately set. As illustrated in FIG. 5, an area in which the related information or the review information is displayed may be separated into a plurality of areas. For example, the review information and the related information may be displayed separately for each portion of the document (each unit of a provision in the present embodiment) to which each of the review information and the related information is related. For example, in the present embodiment, information about an electronic file of a contract document previously concluded with the other party of the contract document may be displayed as related information associated with the Preamble. As related information linked to Section 1 regarding Definition of Confidential Information, the following may be displayed below the indication indicating Section 1 in this order: a search window through which information regarding non-disclosure agreement and definition of confidential information, which is a content provided in Section 1, can be searched for, and a link through which Terms and Conditions of a contract concluded with the same party in the past can be displayed; and two indicated matters such as whether a scope of the confidential information may be sufficiently defined as the review information. As a result, information can be provided for each portion of the document, in particular, for each unit of provisions or the like indicating unity as the meaning of the document, and thus, it is possible to appropriately support review by the user.

In addition, for example, the review information and the related information may be displayed at a position associated with a portion of the document with which each of the review information and the related information is related. Being displayed at an associated position may include, for example, being displayed to be close to the related portion of the document. For example, as illustrated in FIG. 5, the review information and related information for Section 1 may be preferably displayed at a position closer to Section 1 than the review information and the related information for Section 3. Note that, in FIG. 5, the review information display areas R5 regarding Sections 1 to 4 may be collectively indicated by a one-dot chain line.

In addition, display sizes and display positions of the document information display area R1, the related information display area R3, and the review information display area R5 may be fixed or changeable. Further, for example, the document information DI, the related information RI, and the review information may be displayed on the same screen or may be displayed in the same window. Note that a screen for displaying a content of at least one of the related information or the review information may be included in the same screen as the review support screen G1, or may be displayed as a screen different from the review support screen G1. Furthermore, a screen for displaying a content of at least one of the related information or the review information may be a pop-up screen, on-hover display, or the like displayed on the review support screen including the document information DI.

The information processing device 1 according to the present embodiment may generate display information for displaying the related information in a selectable manner for the user on the review support screen G1 illustrated in FIG. 5. When the display information is received in the user terminal 3, the related information may be displayed in a selectable manner for the user on the review support screen G1. Then, when a selection operation is executed by the user, the information processing device 1 may generate display information for displaying a content of the selected related information. Upon receiving the display information, the user terminal 3 may display a screen for displaying the content of the related information. For example, a screen including a link to the selected related information may be displayed to the user. According to this configuration, a detailed content of specific related information selected by the user can be confirmed.

Returning to FIG. 4, the information processing device 1 may edit information included in the review support screen G1, and stores the edited information as an electronic file (step S7).

The document review support system 100 of the present embodiment can edit document information. First, a data format may be converted to generate editing data. For example, the editing processing unit 19 may convert received document data of a “DOCX” format file from an XML format to a “JSON” format to generate editing data.

In addition, the editing processing unit 19 of the present embodiment may execute editing processing on the editing data in response to an editing instruction received from the user terminal 3. Here, the editing processing executed by the editing processing unit 19 may include correcting, adding, deleting, and the like of information included in the editing data as described above. More specifically, the editing processing may include adding, correcting, deleting, and the like of a word, a sentence, or a character decoration (for example, a font, a color of a character, a size of a character, a thickness of a character, an underline, or a strikethrough) with respect to the editing data.

In addition, the editing processing executed by the editing processing unit 19 can include format editing processing, word input assisting processing, draft suggesting processing, indicated matter extraction processing, and difference information extraction processing.

Here, the format editing processing may be, for example, processing of correcting a format of editing data as a document. For example, indent, a line head of itemized writing, right-alignment/left-alignment, deviation of an article number, and the like may be preferably automatically corrected with a system by the format editing processing. For example, the editing processing unit 19 may refer to format information of the support target document corresponding to the editing data, and execute format editing processing on the editing data on the basis of the format information.

Setting of a format as a document may be preferably stored in advance in the information processing device 1, a terminal, or the like on the basis of the type of the support target document such as a contract document. For example, in a case of a legal document such as a contract document or an internal rule, setting may be performed such that sections, paragraphs, and items may be arranged in this order and in an ascending order of article numbers, and indent may be larger in order of sections, paragraphs, and items. In addition, the editing processing unit 19 may execute format editing processing according to a type on the basis of the meta-information of the support target document. Note that this format setting may be created by a user, may be provided as a part of the document browsing support service, or may be created by the user customizing the provided setting. In addition, format setting of the support target document may be interpreted, and may be created on the basis of the interpretation.

The word input assisting processing of the present embodiment may be processing of assisting input, for example, by presenting a candidate word or phrase to be input next at the time of editing document data. As a result, it is possible to support user's input operation at the time of editing and to reduce a workload. For example, a word or the like that frequently appears can be presented as an input candidate according to the type of the support target document. In addition, the support target document stored by a user or an organization to which the user belongs may be analyzed, and a word or the like that is often used may be presented. In addition, a user may set a word or a phrase. The editing processing unit 19 can determine an input candidate word according to a type on the basis of the meta-information of the support target document. A word or the like presented in the input assisting processing may be displayed, for example, in a predetermined window (in a document editing window) of a screen.

The draft suggesting processing of the present embodiment may be, for example, processing of displaying a draft of an input candidate at the time of editing. For example, when the document is a contract document, a correction sentence example based on at least a part of a correction content of the contract document may be read from a database in which a provision draft example is accumulated and presented as a draft candidate. As a result, it is possible to support user's input operation at the time of editing and to reduce a workload.

The editing processing unit 19 may present a predetermined draft candidate, may present a draft candidate determined by a user or a provider of the document browsing support service, may present a draft candidate generated by a sentence generation service inside or outside the present system using an LLM or the like, or may present a draft candidate frequently appearing according to the type of the support target document. In addition, among drafts included in a document stored by a user or an organization to which the user belongs, a draft that is more frequently used than other drafts or a draft that is highly evaluated by the user, a customer including the user, or the like may be presented as a draft candidate. When there are a plurality of draft candidates, at least one draft candidate can be further selected on the basis of an adoption ratio of a provision (a ratio at which a proposed provision is selected by a user) and an adoption frequency in the past document browsing support service, and a candidate with a higher adoption ratio can be preferentially presented to the user. Note that the draft candidate to be presented can be presented as, for example, the document review information or other information.

The editing processing unit 19 can also edit the editing data in response to the editing instruction based on the presented draft candidate, for example, an instruction by a drag and drop operation. This proposed draft may be displayed in association with a corresponding portion of the document in position. For example, the draft candidate may be displayed close to a corresponding portion of the document. With such display, it is possible to compare the draft candidate and the corresponding portion of the document with less movement of a line of sight, and it is possible to reduce a load on a user.

The editing processing unit 19 of the present embodiment may execute the above-described various types of editing processing in response to the editing instruction received from the user terminal 3. In addition, the editing processing unit 19 of the present embodiment may convert a data format of the support target document data or the translation data in response to a storage instruction received from the user terminal 3 to generate document data to be a next version of the support target document. For example, in response to a download instruction or a storage instruction received from the user terminal 3, the editing processing unit 19 can generate document data in a “DOCX” format to be a next version of the support target document using support target document data in a “JSON” format. The editing function in the information processing device 1 may include, for example, editing the document by the user with reference to at least one of displayed review information or related information. The editing function may include, for example, editing using a draft for correction proposal included in the review information, although details will be described later. The editing function may include, for example, at least one of creation, proposal, correction, or insertion of a correction draft in the LLM or the like. In the editing function, document information in the document information display area R1 may be directly editable by the user, or may be editable in response to the user editing the review information or the related information. It is also possible to insert a correction policy or a correction sentence on the review support screen G1. In the storing function, for example, an electronic file may be overwritten and stored, or may be stored as a different version.

In the first example of the document review support processing according to the present embodiment, the information processing device 1 may acquire related information regarding a target document on the basis of a result of the first analysis processing executed on the target document. The information processing device 1 may generate review information regarding document information, on the basis of the second analysis processing regarding a risk included in the document information of the target document. The information processing device 1 may generate display information for displaying the related information and the review information on a screen on which the document information is displayed. Therefore, the user can confirm the related information and the review information together with the document information on the screen on which the document information is displayed. Therefore, it is possible to support the user to easily review the target document. In addition, for example, the document information, the related information, and the review information can be displayed on the review support screen without the user having to press a review button or the like for starting generation processing of the review information as in the conventional case, and thus the time and effort of the user's operation may be reduced.

### Modification of First Example

In the first example of the document review support processing, in step S3, (at the time) when the user terminal 3 uploads one or a plurality of documents to the information processing device 1, the information processing device 1 may execute the first analysis processing on the document, but the present disclosure is not limited thereto. For example, the first analysis processing may be executed on a target document after the target document is selected in the user terminal 3, instead of when the document is uploaded to the information processing device 1 in step S1.

In the first example, the second analysis processing (step S5) may be executed after the first analysis processing (step S3), but the present disclosure is not limited thereto, and the first analysis processing and the second analysis processing may be executed in parallel, or the second analysis processing may be executed before the first analysis processing.

### Second Example

A second example of the document review support processing according to the present embodiment will be described. In the present example, in a case where a predetermined operation (for example, an operation of pressing a review button) is executed after the document information DI and the related information RI are displayed on the review support screen, review information may be further displayed on the review support screen. Hereinafter, points different from the first example will be particularly described.

First, for example, on the basis of the target document and a result of the first analysis processing, the information processing device 1 according to the present embodiment may acquire the related information RI associated with the selected target document from the storage unit 20 illustrated in FIG. 2. The information processing device 1 may transmit, to the user terminal 3, display information for displaying the document information DI and the related information RI on the review support screen of the user terminal 3. Upon receiving the display information for displaying the document information DI and the related information RI on the review support screen, the user terminal 3 may display the document information DI and the related information RI on the review support screen.

Next, when the user presses, for example, a review button for executing review on the review support screen displayed on the user terminal 3, the user terminal 3 may transmit, for example, an instruction regarding execution of the second analysis processing to the information processing device 1. The information processing device 1 may execute the second analysis processing on the target document and generates review information. The information processing device 1 may transmit, to the user terminal 3, the display information for displaying the document information DI, the related information RI, and the review information on the review support screen of the user terminal 3. Upon receiving the display information for displaying the document information DI, the related information RI, and the review information on the review support screen of the user terminal 3, the information processing device 1 may display the review information in addition to the document information DI and the related information RI on the review support screen as illustrated in FIG. 5.

Note that, in the second example of the document review support processing, in the user terminal 3, first, the document information DI and the related information RI may be displayed on the review support screen, and then the review information may be further displayed on the review support screen, but the present disclosure is not limited to this display form. For example, in the user terminal 3, the document information DI and the review information may be displayed first on the review support screen, and then the related information RI may be further displayed on the review support screen.

In the second example of the document review support processing according to an embodiment, the document information, the related information, and the review information may not be displayed at once on the review support screen, but the related information and the review information can be sequentially displayed with an operation of the user as a trigger.

### Hardware Configuration

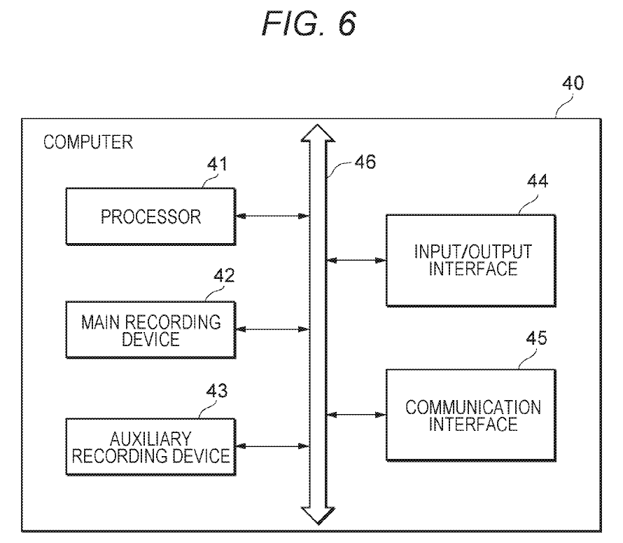

FIG. 6 is a diagram illustrating an example of a hardware configuration of a computer according to an embodiment. An example of a hardware configuration of a computer that can be used to constitute the information processing device 1 and the user terminal 3 illustrated in FIG. 1 will be described with reference to FIG. 6.

As illustrated in FIG. 6, a computer 40 may mainly include, as hardware resources, at least one processor 41, a main recording device 42, an auxiliary recording device 43, the input/output interface 44, and a communication interface 45, which are connected to each other via a bus line 46 including an address bus, a data bus, a control bus, and the like. Note that an interface circuit (not illustrated) may be appropriately interposed between the bus line 46 and each hardware resource.

The processor 41 may control the entire computer. The processor 41 may correspond to, for example, the information processing unit 10 of the information processing device 1 illustrated in FIG. 2 and the information processing unit 30 of the user terminal 3.

The main recording device 42 may provide a work area for the processor 41 and may be a volatile memory such as a static random-access memory (SRAM) or a dynamic random-access memory (DRAM).

The auxiliary recording device 43 may be a non-volatile memory such as an HDD, an SSD, or a flash memory that stores a program or the like as software, data, and the like. The program, data, and the like may be loaded from the auxiliary recording device 43 to the main recording device 42 via the bus line 46 at any time point. The auxiliary recording device 43 may correspond to, for example, the storage unit 20 of the information processing device 1 illustrated in FIG. 2 and the storage unit 36 of the user terminal 3.

The input/output interface 44 may perform one or both of presenting information and receiving input of information, and may be a camera, a keyboard, a mouse, a display, a touch panel display, a microphone, a speaker, or the like.

The communication interface 45 may be used by the information processing device 1 and the user terminal 3 to transmit and receive various data via the communication network N illustrated in FIG. 1. The communication interface 45 and the communication network N may be connected in a wired or wireless manner. The communication interface 45 may also acquire information regarding a network, for example, information regarding an access point of Wi-Fi, information regarding a base station of a communication carrier, and the like.

It will be apparent to those skilled in the art that the cooperation of the above exemplified hardware resources and software enables the computer 40 to function as a desired means, execute desired steps, and implement desired functions.

Note that the embodiment described above is intended for easy understanding of the present disclosure and thus does not interpret the present disclosure in a limited manner. Modifications or alterations of the present disclosure may be made without departing from the gist of the present disclosure, and equivalents thereof are included in the present disclosure. Furthermore, the present disclosure can form various disclosures by appropriately combining the plurality of components disclosed in the embodiment described above. For example, some components may be deleted from all the components illustrated in the embodiment. Moreover, components of different embodiments may be appropriately combined.

### Other Embodiments

As described above, services provided by the document review support system 100 according to the embodiment described above may include the above-described services (1) to (8) on a web browser in the user terminal 3, but are not limited to these services. For example, the services may include reception of matters and allocation of persons in charge of the matters in a company described above, a service for comparing a plurality of documents (for example, a service for clearly indicating difference information), a file version management service, a service for describing correspondence with and handover notes to and from a requester or a legal staff member in a company, and an electronic signature service.

The document review support system 100 may compare a plurality of documents, for example, different versions of a document for which a plurality of versions exist, and present differences and other portions (that is, the same portions) to the user in a predetermined display form of displaying the differences and other portions differently, for example, emphasizing or highlighting the differences.

Furthermore, difference information obtained by summarizing the extracted differences may be generated and presented to the user.

The document review support system 100 may be able to specify differences in table data in a tabular form included in a document. That is, the document review support system 100 may acquire a first document including first table data and a second document including second table data, and specify a correspondence between a cell included in the first table data and a cell included in the second table data on the basis of similarity of content data included in the cells. The document review support system 100 may specify a difference indicating different portions of the first table data and the second table data. The document review support system 100 may output display data for highlighting the differences and displaying at least one of the first table data or the second table data.

The document (for example, the first document and the second document) may include at least table data in a tabular form processed by the document review support system 100.

The second document may be, for example, a document generated on the basis of the first document. That is, the second document may be a document generated by editing the first document, or may be a document generated by further editing a document generated by editing the first document.

In addition, the document may be a legal document. Here, the legal document may be, for example, a bylaw or a contract document. The bylaw or the contract document may be, for example, an electronic document created by predetermined electronic document creation software, or an electronic document obtained by digitization of a contract document of a paper medium using a predetermined image analysis technology (for example, an optical character recognition (OCR) technology). The bylaw or the contract document may be, for example, a document including an article and generating a predetermined legal effect, and also includes an application form, a memorandum, and the like.

The bylaw or the contract document may include not only a document agreed to by both parties but also a document that is being confirmed by both parties (that is, a draft of the bylaw or the contract document), a document that has been exchanged between the parties but has not reached an agreement, or a template document prepared for reference in a contract or the like with another party. In the description of the present embodiment, unless otherwise specified, the bylaw or the contract document may include not only a document agreed to by both parties but also a document that is being confirmed by both parties (that is, a draft of the bylaw or the contract document), a document that has been exchanged between the parties but has not reached an agreement, or a template document prepared for reference in a contract or the like with another party.

The table data (for example, the first table data and the second table data) may be data related to a table. The table data may be, for example, data in which each cell is associated with content data included in the cell.

The table data may be, for example, data of a table in which targets, ranges, and the like of legal effects generated by a document are organized for each item. That is, the table data may be table data in which details of a contract (for example, the contract start date, the contract end date, and the amount of the contract) are organized for each item. In addition, in a case where the document is contract data related to transactions or lease of real estate, the table data may be, for example, table data in which details of the property and the contract (for example, the address, the occupied area, the start date of the lease, the end date of the lease, and the rent of the property) are organized for each item. In addition, in a case where the document is contract data related to a deposit contract, the table data may be table data in which a list of items as targets of the deposit contract is organized.

The file version management service may be specifically described below. The document review support system 100 may be an information processing system implemented by a document processing program. The document review support system 100 may acquire a first comparison document to be compared with a target document as a review target, and extract and displays a second comparison document (that is, for example, an electronic document different from the first comparison document) in accordance with the user's operation. In other words, the document review support system 100 may switch a comparison target from the first comparison document to the second comparison document.

For example, the document review support system 100 can use, as the first comparison document, a first similar document that is similar to the target document. In addition, for example, the document review support system 100 can use, as the second comparison document, a second comparison document belonging to the same series of correction processes as the first comparison document, particularly, for example, a second similar document belonging to the same series of correction processes as the first similar document. Here, the first comparison document may be the first similar document and the second comparison document may be the second similar document, but the first comparison document and the second comparison document are not limited thereto. That is, the first similar document and the second similar document may be appropriately read as the first comparison document and the second comparison document, respectively.

When the user reviews the target document, the user may refer to a correction process in an electronic document (the first similar document to be described later) similar to the target document and an electronic document (the second similar document to be described later) corrected by the correction process. Thus, the user can review the target document with reference to correction in a past document (for example, a past similar document). The document review support system 100 may be an information processing system that performs document processing regarding reference of the second similar document by the user.

The document review support system 100 can download various types of information. The document review support system 100 can download an electronic file including at least one of document information, review information, or related information, for example. For example, a DOCX file or a tabular file can be downloaded in which the review information and the related information are attached to the document information as a comment of a Word file. The document review support system 100 can download, for example, an electronic file including document information after document comparison processing and a result of the comparison processing. The document review support system 100 can download, for example, an electronic file of a document added with an editing history, an electronic file of a final version document or a confirmed version document, a list of matters, a list of related information, and the like.

What is claimed is:

1. An information processing method executed by a processor,
the information processing method comprising:
acquiring related information regarding a target document, based on a result of first analysis processing executed on the target document;
generating review information regarding document information of the target document, based on second analysis processing regarding a risk included in the document information; and
generating display information for displaying the related information and the review information on a screen on which the document information is displayed.

2. The information processing method according to claim 1, comprising:
generating display information for displaying the related information in a selectable manner for a user, in a case where the related information and the review information are displayed on a screen on which the document information is displayed; and
generating display information for displaying a content of the selected related information when a selection operation is executed by the user.

3. The information processing method according to claim 1, further comprising:
generating display information for displaying the related information and the review information on the screen when the document information is displayed.

4. The information processing method according to claim 1, further comprising:
executing the first analysis processing upon acquiring one or a plurality of documents from an external device via a communication network.

5. The information processing method according to claim 1, wherein
the target document is a legal document, and
the related information includes at least one of a document, a law, a case, a provision, a comment by a user, or data held by a user, that are related to the legal document.

6. An information processing system comprising at least one processor, wherein
the at least one processor is configured to perform:
acquiring related information regarding a target document, based on a result of first analysis processing executed on the target document;
generating review information regarding document information of the target document, based on second analysis processing regarding a risk included in the document information; and
generating display information for displaying the related information and the review information on a screen on which the document information is displayed.

7. A non-transitory computer-readable storage medium storing a program for causing a computer to perform a method, the method comprising:
acquiring related information regarding a target document, based on a result of first analysis processing executed on the target document;
generating review information regarding document information of the target document, based on second analysis processing regarding a risk included in the document information; and
generating display information for displaying the related information and the review information on a screen on which the document information is displayed.
